(19) United States
(12) Patent Application Publication
(10) Pub. No.: US 2013/0164965 A1
(43) Pub. Date: Jun. 27, 2013

(54) CONNECTOR WITH ROTATABLE LATCHING ELEMENT

(71) Applicants: XIAO-GANG YIN, Shenzhen City (CN); WEN-SEN HU, Shenzhen City (CN); GUO-YI CHEN, Shenzhen City (CN)

(72) Inventors: XIAO-GANG YIN, Shenzhen City (CN); WEN-SEN HU, Shenzhen City (CN); GUO-YI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/563,845

(22) Filed: Aug. 1, 2012

(30) Foreign Application Priority Data
Dec. 21, 2011 (CN) 201110432349.9

(51) Int. Cl. H01R 13/62

(52) U.S. Cl. 439/357

(57) ABSTRACT

A connector includes a connector body, a connector head and a latching element. The connector head is integrally formed at one end of the connector body, and the connector body and the connector heat define a slot. The latching element includes a plate body, a latching protrusion, and an elastic branching plate. The elastic branching plate branches from the plate body. The latching element is rotatably received in the slot, and the protrusion is releasably latched with a port of an electronic apparatus.

### BACKGROUND

1. Technical field

The disclosure generally relates to a connector with a rotatable latching element which is stably connected to a port of an electronic apparatus.

2. Description of the Related Art

Hard disks in computer servers usually adopt a serial advance technology attachment (SATA) port. A connector is used for electronically connecting the SATA port. The connector usually has a latching protrusion slidably latched in the port. However, the latching protrusion wears out after a period of time and can no longer be tightly latched with the port, affecting the electronic connecting of the connector and the port.

Therefore, there is room for improvement within the art.

### BRIEF DESCRIPTION OF THE DRAWINGS

Many aspects of an exemplary connector can be better understood with reference to the following drawings. The components in the drawings are not necessarily drawn to scale, the emphasis instead being placed upon clearly illustrating the principles of the exemplary connector. Moreover, in the drawings, like reference numerals designate corresponding parts throughout the several views. Wherever possible, the same reference numbers are used throughout the drawings to refer to the same or like elements of an embodiment.

FIG. 1 is a schematic view of a connector plugged in a receptacle of a storage apparatus according to an exemplary embodiment.

FIG. 2 is an exploded view of the connector and the receptacle.

FIG. 3. is an exploded view of the connector.

FIG. 4. is a cross-sectional view of the connector plugged in the receptacle taken along line IV-IV in FIG. 1.

### DETAILED DESCRIPTION

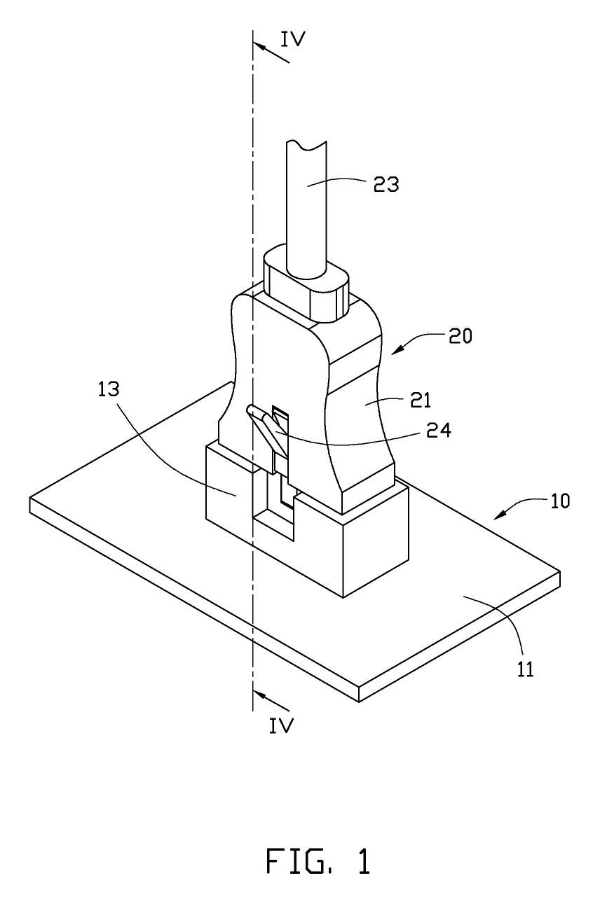

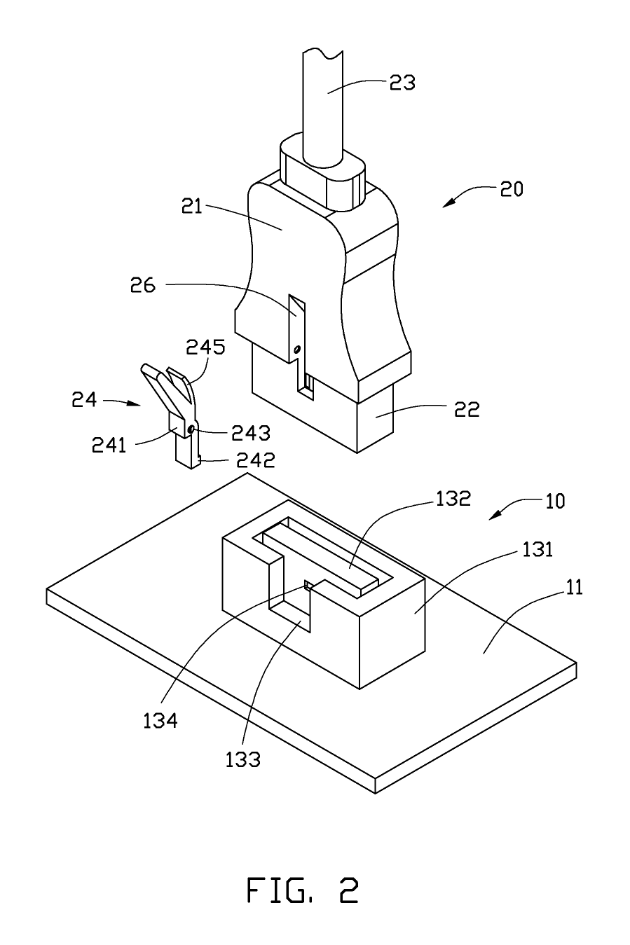

Referring to FIGS. 1 and 2, a connector 20 is used for connection with an connector receptacle 10, such as used with a storage apparatus such as a hard disk (not shown). The connector receptacle 10 includes a printed circuit board 11 and a port 13. In the exemplary embodiment, the port 13 adopts SATA type. The connector 20 is configured for inserting into the port 13 to form an electrical connection in data communication or telecommunication applications.

The port 13 includes an insulating body 131 and a tongue plate 132. A notch 133 is defined in the insulating body 131. The tongue plate 132 is received in the insulating body 131. One side of the tongue plate 132 defines a groove 134, and a plurality of contacts (not shown) are formed on an opposite side of the tongue plate 132 for electronically connecting the connector 20.

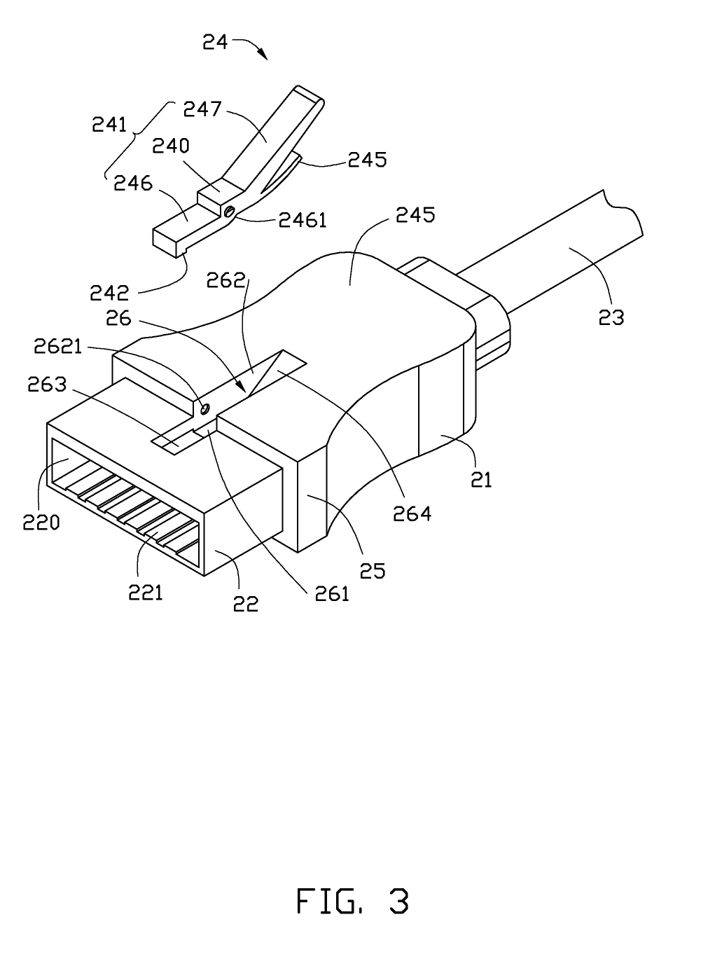

Referring to FIG. 3, the connector 20 includes a connector body 21, a connector head 22, a wire 23 and a latching element 24. The connector head 22 is integrally formed at one end of the connector body 21, and the wire 23 is connected at another end of the connector body 21. The connector head 22 defines a rectangular chamber 220. A plurality of conductive contacts 221 are formed in an inner side of the chamber 220 for electrically the connecting the wire 23 and the port 13. The connector 20 defines a slot 26 which is recessed at one side of the connector body 21 and the connector head 22. The slot 26 is cooperatively defined by a bottom surface 261, two side surfaces 262 and a slope 264. A cutout 263 is defined in the bottom surface 261 spaced apart from the slope 264. The cutout 263 communicates the bottom surface 261 to be connected to the chamber 220. Each side surface 262 defines an axis hole 2621.

The latching element 24 is made of elastic material, and includes a plate body 241, a latching protrusion 242 and an elastic branching plate 245. The plate body 241 includes a fixing plate 246, a neck portion 240 and a pressing plate 247. The fixing plate 246 and the pressing plate 247 are respectively formed at opposite ends of the neck portion 240. The pressing plate 247 is tilted relative to the neck portion 240. The elastic branching plate 245 is adjacent to the pressing plate 247, and is branched from the neck portion 240. Two pivots 2461 are respectively formed at opposite sides of the neck portion 240 for rotatably engaging in the axis holes 2621.

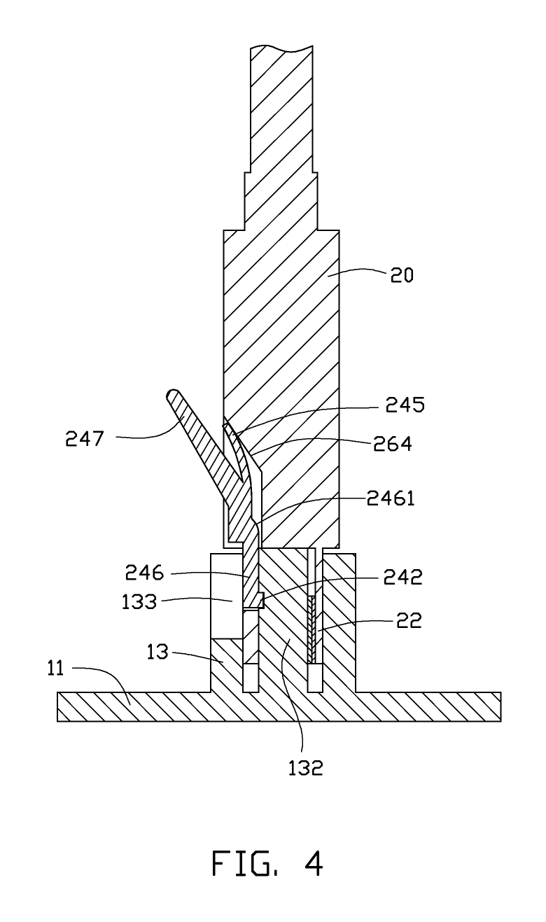

Referring to FIG. 4, in assembly, the latching element 24 is assembled into the slot 26 of the connector 20. The pivots 2461 are rotatably received in the axial holes 2621, and the fixing plate 246 abuts the stepped bottom surface 261. The latching protrusion 242 extends through the cutout 263 is received in the chamber 220 of the connector head 22.

When the connector 20 is prepared to be inserted into the connector receptacle 10, the connector head 22 is aligned with the port 13. The pressing plate 247 is pressed to rotate the fixing plate 246 outward relative to the connector 20. Accordingly, the protrusion 242 rotates out of the chamber 220 and the cutout 263, and the branching plate 245 is deformedly pressed against the slope 262. The fixing plate 246 is rotated to be received in the notch 133. Then, the connector head 22 is inserted into the port 13, and the tongue board 132 is received in the chamber 220 of the connector head 22. The pressing plate 247 is then released, and the protrusion 242 enters the cutout 263 and the chamber 220 from the notch 133, and is latched in the groove 134. The branching plate 245 biases the latching protrusion 242 to tightly press the tongue plate 132.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A connector comprising:
a connector body and a connector head, the connector head integrally formed at one end of the connector body, the connector body and the connector head defining a slot;
a latching element including a plate body, a latching protrusion and an elastic branching plate, the elastic branching plate branching from the plate body;
wherein the latching element is rotatably received in the slot, whereby the protrusion can be releasably latched with a receptacle of an electronic apparatus.

2. The connector as claimed in claim 1, wherein two opposite pivot holes are defined in the slot, two pivots are formed at opposite sides of the plate body for rotatably engaging in the pivot holes.

3. The connector as claimed in claim 2, wherein the plate body includes a fixing plate, a neck portion and a pressing plate, the fixing plate and the pressing plate are respectively formed at opposite ends of the neck portion.

4. The connector as claimed in claim 3, wherein the elastic branching plate is adjacent to the pressing plate, and is branched from the neck portion.

5. The connector as claimed in claim 1, wherein the slot is cooperatively defined by a stepped bottom surface, two side surfaces and a slope, a cutout is defined in the bottom surface, and spaced apart from the slope, each side surface defines an axis hole, and two pivots are formed at opposite sides of the plate body for rotatably engaging in the pivot holes.

6. A connector assembly comprising:
a connector including a connector head and a latching element, the latching element rotatably received in the connector;
a connector receptacle including a port, the port including an insulating body and a tongue plate in the insulating body, the connector head inserted into the port, the latching element rotatable to abut against the tongue plate to electronically connect the connector to the connector receptacle.

7. The connector assembly as claimed in claim 6, wherein the connector includes a connector body, the connector head integrally formed at one end of the connector body, the connector body and the connector head defines a slot, and the latching element is rotatably received in the slot.

8. The connector assembly as claimed in claim 7, wherein two opposite pivot holes are defined in the slot, the latching element includes a plate body, a latching protrusion and an elastic branching plate, the elastic branching plate branching from the plate body, two pivots are formed at opposite sides of the plate body for rotatably engaging in the pivot holes.

9. The connector assembly as claimed in claim 8, wherein the plate body includes a fixing plate, a neck portion and a pressing plate, the fixing plate and the pressing plate are respectively formed at opposite ends of the neck portion.

10. The connector assembly as claimed in claim 9, wherein the elastic branching plate is adjacent to the pressing plate, and is branched from the neck portion.
